(19) United States
(12) Patent Application Publication
(10) Pub. No.: US 2013/0059045 A1
(43) Pub. Date: Mar. 7, 2013

(54) OVEN BAKED FRENCH FRY WITH REDUCED ACRYLAMIDE LEVEL

(71) Applicant: Franklin S. Tiegs, Pasco, WA (US)

(72) Inventor: Franklin S. Tiegs, Pasco, WA (US)

(21) Appl. No.: 13/587,723

(22) Filed: Aug. 16, 2012

Related U.S. Application Data
(60) Provisional application No. 61/531,698, filed on Sep. 7, 2011.

(51) Int. Cl. A23L 1/217; A23L 1/22; A23L 1/237; A23L 1/275

(52) U.S. Cl. 426/250; 426/540

(57) ABSTRACT

An oven baked French fry with reduced and relatively low acrylamide level. Raw cut strips are initially subjected to an extended blanch step for increased sugar leaching and to prepare the strips with a preferred soft internal texture. A coloring agent such as annatto or the like is included within the blanching medium, or otherwise added during a post-blanching dwell step. The blanched strips are next dried for an extended time period at a relatively low dryer temperature to produce controlled moisture reduction without becoming tough and chewy. The dried strips then travel through a hot air impingement oven at a mid-range temperature for a relatively short time interval. The air-impinged strips are then frozen, followed by oil coating and optional seasoning. The thus-treated strips are finish prepared by oven baking to produce finished strips having high quality sensory attributes, in combination with an unexpectedly low acrylamide level.

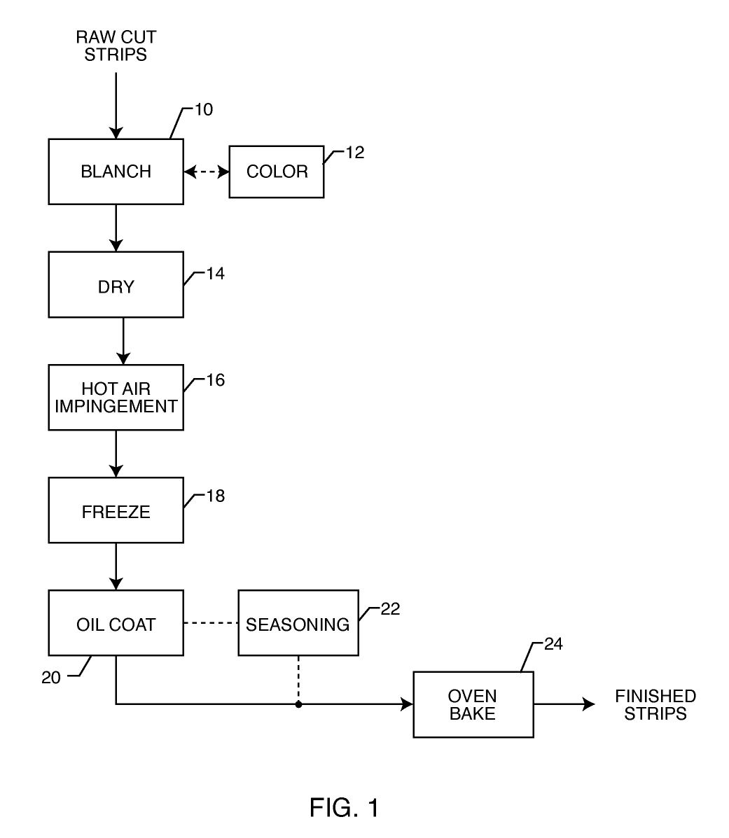

### BACKGROUND OF THE INVENTION

This invention relates generally to improved French fry potato strips or pieces such as elongated French fry strips which are pre-processed without parfrying, and which are suitable for finish preparation by oven baking (without frying) to exhibit a highly desirable set of taste, texture and appearance characteristics in combination with a highly desirable low acrylamide level.

Parfried and frozen potato strips or pieces, commonly referred to as French fries, are widely available in the foods industry. These potato products are conventionally prepared by cutting whole potatoes into pieces such as elongated strips of a desired size and shape, and then partially cooking the potato strips by blanching in hot water or steam. Thereafter, the potato strips are typically dipped into an aqueous-based color development solution including dextrose. The thus-dipped potato strips are then partially fried, or parfried, by immersion in hot cooking oil, followed by freezing for packaging, shipping and/or storage. Prior to consumption, the parfried and frozen potato strips are reconstituted or finish prepared typically by finish frying in hot oil. French fried potato strips of this type are utilized extensively in restaurant and food service operations, and particularly in so-called fast food restaurants wherein it is desirable to produce a finish cooked product with a substantially optimized set of quality characteristics and with a relatively short finish fry preparation time.

More specifically, one major objective of potato processors is to provide frozen potato strips which can be finish prepared with a combination of taste, color, odor, and textural attributes selected for substantially optimum consumer palatibility. For example, it is highly desirable to provide parfried and frozen potato strips which, after finish preparation as by frying (immersion in hot oil), exhibit a light and tender but crispy exterior surface of golden brown fried color encasing a soft and mealy interior which is neither too dry nor too soggy. Moreover, especially in a fast food restaurant environment or food service facility, it is important to provide finish cooked potato strips which can consistently retain these desired sensory qualities for an extended holding period of at least several minutes before actual consumption. In the past, achieving these desirable product qualities on a consistent basis has generally required that the potato strips be finish prepared by immersion-frying in hot oil. In a typical food service facility (such as a fast food restaurant, or noncommercial facilities such as schools and universities, business cafeterias, hospitals, etc.), to avoid advance preparation of potato strips that might not be sold or served within a limited holding time of several minutes, a relatively short finish fry step is desired and is typically on the order of about 2-3.25 minutes for smaller so-called shoestring size cut strips and about 3-4 minutes for larger strips cut sizes.

In prior art French fry production processes, color development has been related to sugar content prior to the parfry or finish fry steps. In this regard, raw potatoes are known to exhibit an inherent or natural sugar content which increases over time as the potatoes are held in storage prior to processing. This natural sugar content is then normally supplemented by adding an appropriate quantity of a reducing sugar such as dextrose to an aqueous-based solution applied to the cut surfaces of production strips after blanching, and prior to parfrying. Then, when subjected to subsequent parfrying and finish frying steps, the reducing sugar cooperates with the inherent or natural raw potato sugars to insure sufficient color development so that the finish prepared products exhibit the desirable crispy exterior surface texture having the desired golden brown fried color.

While the presence of sufficient reducing sugars such as natural sugars and/or dextrose insures that the finish fried potato pieces exhibit the desirable golden brown fried color, it has been recognized recently that these reducing sugars result in proportionally increased levels of acrylamide in the finished product. In this regard, acrylamide levels on the order of 300 parts-per-billion (ppb) and higher (400-700 ppb) are typical in potato pieces having a substantially optimized color development in a finish fried state. It is believed that acrylamide is produced when a reducing sugar together with the amino acid asparagine are subjected to hot oil at a relatively high finish fry temperatures, and/or to relatively high oven temperatures. Attempts to produce a French fried potato product in the absence of a reducing sugar have resulted in finish fried products having insufficient color development for consumer acceptance.

Alternatively, oven finish preparation of French fries has been attempted in an effort to overcome the disadvantages and problems associated with parfrying and/or finish frying, as described above. In such over finish preparation processes, the French fries are oven heated in a conventional or a convection oven immediately before serving. However, upon such oven finish preparation, significant alternative disadvantage also result, such as a long bake time, scorched surfaces, and accompanying relatively high acrylamide levels. In addition, such French fries are typified by a limp and soggy texture, or alternatively, a tough and chewy texture.

There exists, therefore, a significant need for improvements in and to French fry potato processing technology, to produce a finish cooked potato product having a desirable blend of quality taste, texture and appearance characteristics, in combination with a desirably low acrylamide level. The present invention fulfills these needs and provides further related advantages.

### SUMMARY OF THE INVENTION

In accordance with the invention, an oven baked, non-parfried and non-fried French fry is provided with reduced and relatively low acrylamide levels. Initially, raw cut strips are subjected to an extended blanch step for increased sugar leaching and so that the strips exhibit a preferred soft internal texture. The blanching medium preferably includes a selected coloring agent, such as annatto or the like. After blanching, the strips are next dried for an extended time period at a relatively low dryer temperature to produce controlled moisture reduction thereby forming a crispy skin that is not tough and chewy on the strips. The dried strips are then subjected to a hot air impingement step at a mid-range temperature for a relatively short time interval, without parfrying of the strips. The air-impinged strips are then frozen, followed by light oil coating and optional seasoning. The thus-treated strips are finish prepared by oven baking to produce finished strips having high quality sensory taste, texture and appearance attributes, in combination with an unexpectedly low acrylamide level.

In a preferred process, raw cut strips are formed in a selected cut size and shape, with a selected length or range of lengths distribution. The raw cut strips are initially blanched in hot water or steam of extended duration, typically about 175-190° F., for a time period of about 25-35 minutes. Preferably, the raw cut strips are preheated before blanching to a temperature within the range of about 130-155° F., for a time period of about 30-60 minutes. During this extended blanching step, the strips are cooked more closely to completion, in comparison with prior art blanching steps wherein the potato strips are merely gelatinized preparatory to parfrying. Specifically, the interior surfaces of the potato strips are cooked during blanching to a preferred soft and mealy internal texture more consistent with the internal texture of traditional parfried potato strips, but also with increased sugar leaching.

The blanching medium preferably includes a selected coloring agent, such as annatto, in an amount designated by the food service operator. Annatto is typically added within a range of from about 0.0007% to about 0.10% by weight. Alternatively, the coloring agent can be applied post-blanch in a water-borne transport or dwell step of about 15 seconds to about 30 minutes as the strips are transferred from the blancher to subsequent processing equipment.

The blanched (and colored) strips are next dried for an extended time period but at a relatively lower dryer temperature to produce controlled moisture reduction thereby forming a crispy skin that is not tough and chewy on the strips. In one preferred form, the strips are dried for about 65-105 minutes at a temperature of about 80-125° F. to produce dried strips having a moisture content of about 75% by weight, in combination with a relatively crispy outer skin.

The thus-dried strips then enter into an air impingement oven set at a mid-range temperature of about 250-400° F., for a short time interval on the order of about 1-3 minutes.

The air-impinged strips are then frozen, followed by enrobing of the frozen strips with a light coating of oil to produce frozen oil-coated strips having an oil content of about 0.5-2.5% by weight. One preferred oil comprises a partially hydrogenated soy-based vegetable oil. However, since the potato strips are not subjected to a frying temperature, so-called healthy oils such as olive oil, high oleic soybean and/or canola oil, sunflower oil, safflower oil, and liquid canola oil and the like can be used. Such so-called healthy oils are characterized by being low in saturated fat, the absence of trans fat, and a high level of mono or polyunsaturated fat.

The frozen strips may also be seasoned, as by salting or addition of alternative selected seasonings. Salt is typically added at a rate of about 0.2-2.5% by weight. If a blended seasoning is used, a range of seasoning addition is on the order of about 1.0-10.0% by weight.

The thus-frozen and oil-coated potato strips are finish prepared by baking in an oven, such as in a conventional or a convection oven. In this regard, conventional shoestring size cut strips are baked substantially in a monolayer at a temperature of about 375-450° F. for a time period of about 6-30 minutes. More particularly, in a conventional oven, a preferred finish preparation process involves baking substantially in a monolayer at a temperature of about 375-450° F. for a time period of about 8-25 minutes. In a convection oven, a preferred finish preparation process involves baking substantially in a monolayer at a temperature of about 400-450° F. for a time period of about 6-12 minutes. In either case, the resultant potato strips have a moist and mealy interior encased within a light and tender crispy exterior of desirable golden brown color, in combination with an extremely and unexpectedly low acrylamide level of the order of about 20-40 parts per billion (ppb), and preferably less than about 30 ppb.

Other features and advantages of the invention will become more apparent from the following detailed description, taken in conjunction with the accompanying drawing, which illustrates the invention.

### BRIEF DESCRIPTION OF THE DRAWINGS

The accompanying drawing illustrates the invention. In such drawing, the accompanying FIGURE is a flow chart representing the process steps comprising the invention.

### DETAILED DESCRIPTION OF THE PREFERRED EMBODIMENTS

The present invention relates to improved French fry potato pieces or strips and a related preparation process, wherein the potato strips are not subjected to parfrying or frying but instead are adapted for oven baking to produce finished potato strips exhibiting a desirable combination of taste, appearance, and texture characteristics together with an unexpectedly low acrylamide level.

In general terms, the potato pieces or strips are cut from raw potatoes to have a desired and preferably elongated size and shape. In this regard, so-called shoestring size potato strips can be cut from peeled or unpeeled raw potatoes each to have a substantially square-cut cross section of about 0.30 inch per side. These cut potato strips have a length distribution according to the lengths of the raw potatoes being cut, with a typical length distribution ranging from about 2 inches to about 6 inches. Persons skilled in the art will understand that different cutting equipment can be used for cutting the raw potatoes, such as so-called hydraulic cutters wherein raw potatoes are propelled in single file by a water stream or flume into impact cutting engagement with a grid of so-called water knives for cutting each raw potato into a plurality of elongated strips of selected size and shape. See, e.g., U.S. Pat. Nos. 3,109,468; 3,116,772; 3,208,625; 4,082,024; 4,135,002; 4,372,184; and 4,423,652, all of which are incorporated by reference herein. Alternately, persons skilled in the art will also understand that mechanical type cutting equipment can be used, such as the cutter shown and described in U.S. Pat. No. 3,139,130, which is also incorporated by reference herein.

The cut raw potato strips are initially subjected to a blanch step 10 (see accompanying drawing) in hot water or steam of extended time duration for substantially fully cooking the interiors of the strips to a desirably soft and mealy interior texture. Concurrent with blanching, or immediately thereafter, a coloring step 12 wherein a coloring agent such as annatto is optionally used for dying the potato strips for selected color development. Thereafter, the blanched and dyed strips are dried in a drying step 14 for an extended time period but at a relatively low dryer temperature to develop a crispy texture outer skin which is not tough and chewy. The dried strips are then subjected to a roasting step 16 wherein the strips are passed into and through an air impingement oven for a short roast interval to complete the crispy texture outer skin. Thereafter, the air-impinged strips are frozen (step 18), followed by application of a light surface coating of a selected oil (step 20), and, if desired, selected seasonings (step 22).

The thus-prepared and frozen potato strips are finish prepared for consumption by oven baking (step 24). In this regard, the finished strips exhibit a highly desirable blend of taste, texture and appearance characteristics closely emulating conventional parfried and/or finish fried potato strips, but also exhibiting a surprisingly and unexpectedly low acrylamide level on the order of about 20-40 ppb.

More specifically, in accordance with the present invention, raw cut potato strips are initially subjected to the blanch step 10 preferably in hot water for an extended time period. In a preferred form, this initial blanch step 10 cooks the potato strips for a time period of about 25-35 minutes, at a blanching medium (water) temperature within a range of about 175-190° F. Most preferably, the raw cut strips are preheated before blanching to a temperature within the range of about 130-155° F., for a time period of about 30-60 minutes. The resultant potato strips are substantially fully cooked throughout to exhibit (after drying and air impingement steps to be described) a desirably soft and mealy interior suitable for immediate consumption. However, due to the extended time involved in the blanching step, sugars which undesirably contribute to acrylamide formation in the as-consumed finished product tend instead to be leached from the blanched strips.

The blanched potato strips are subjected to a surface application 12 of an aqueous dye solution, such as a food grade color agent, e.g., an annatto based solution, for imparting to the strips a selected degree of substantially yellow or golden brown color. This aqueous dye solution comprises, in the preferred form of the invention, the blanching medium (water) to which a selected amount of the dye (such as annatto) has been added. Alternately, if desired, the dye solution can be used to surface-coat the strips upon exiting the blancher, as by dipping or spraying as the strips are transported over a period of about 15 seconds to about 30 minutes to subsequent processing equipment (to be described). In either case, in accordance with a preferred form of the invention, the surface-dyed strips exhibit an annatto-based color on the USDA approved Munsell color chart of about 0-3.

The blanched and optionally dyed potato strips are then transported to the drying step 14 for extended time exposure to a relatively low dryer temperature designed to form a desirably crispy exterior surface on the strips, without undesirable tough and/or chewy traits. In the preferred form, the strips are dried for about 65-105 minutes at a temperature of about 80-125° F. to produce dried strips having a moisture content of about 75% by weight, in combination with the desirable and relatively crispy outer skin. One preferred dryer comprises a four stage conveyor dryer marketed by Aeroglide Corporation, of Cary, N.C., under the product designation 63262.

The thus-dried potato strips are then transported to the roasting or air impingement step 16, wherein the strips are exposed to heated air at a mid-range temperature of about 250-400° F., for a short time interval on the order of about 1-3 minutes. This air flow is relatively dry, within a relative humidity range of about 30-70%. The resultant air-impinged potato strips exit the air impinger with a substantially fully developed crispy outer skin surface encasing a moist and mealy interior, while exhibiting a weight loss within the air impinger of about 5-30%. While different air impingement (roaster) equipment can be used, one preferred form comprises that marketed by Wolverine Corporation of Merrimac, Mass., under the product designation jetzone SB.

The air-impinged potato strips are then promptly frozen in the freeze step 18, as by passage within a blast freezer set at about −20° F. The frozen strips are then lightly surface coated with a selected cooking oil (step 20) to produce frozen oil-coated strips having an oil content of about 0.25-2.5% by weight. One preferred oil comprises a partially hydrogenated soy-based vegetable oil. However, since the potato strips are not subjected to a frying temperature, so-called healthy oils such as olive oil, high oleic soybean and/or canola oil, sunflower oil, and/or safflower oil, and the like can be used. Such so-called healthy oils are characterized by being low in saturated fat, the absence or substantial absence of trans fat, and a high level of mono or polyunsaturated fat.

The frozen strips may also be seasoned (step 22), as by salting or addition of alternative selected seasonings. Salt is typically added at a rate of about 0.25-2.5% by weight, and preferably about 1.5% by weight. If a blended seasoning is used, a range of seasoning addition is on the order of about 1.0-10.0% by weight.

The thus-frozen potato strips can be held in frozen storage for an extended period of time, to accommodate storage and/or shipment (in the frozen state) to a customer such as to a fast food restaurant or other food service facility. At the restaurant or other food service facility, the frozen potato strips are adapted for finish preparation without frying by baking in an oven (step 24). In this regard, conventional shoestring size cut strips are baked substantially in a monolayer at a temperature of about 375-450° F. for a relatively short time period of about 6-30 minutes. More particularly, in a conventional oven, a preferred finish preparation process involves baking substantially in a monolayer at a temperature of about 375-450° F. for a time period of about 8-25 minutes. In a convection oven, a preferred finish preparation process involves baking substantially in a monolayer at a temperature of about 400-450° F. for a time period of about 6-12 minutes. In either case, the resultant potato strips have a moist and mealy interior encased within a light and tender crispy exterior of desirable golden brown color, in combination with an extremely and unexpectedly low acrylamide level of the order of about 20-40 parts per billion (ppb), and preferably less than about 30 ppb.

Accordingly, the combination of the extended blanch step and the extended drying step together with the short roasting step (air impingement) and the light surface coating of oil in the frozen state is believed to contribute to the finished characteristics of the resultant oven baked French fry product, which has not been parfried and fried at any step in the process and thereby exhibits a surprisingly low acrylamide level on the order of less than about 30 ppb. The taste, texture, and appearance of the oven baked potato strips of the present invention closely emulates traditional parfried potato strips which are finish prepared either by finish frying or by oven baking, but also exhibit a highly desirable low acrylamide level.

A variety of modifications and improvements in and to the oven baked potato strips and the related preparation process will be apparent to persons skilled in the art. For example, such alternative and/or additional food grade color agents may include or comprise annatto, tumeric, b-carotene, and others, and mixtures thereof. Accordingly, no limitation on the invention is intended by way of the foregoing description, except as set forth in the appended claims.

What is claimed is:

1. A process for preparing French fry potato strips, comprising the steps of:
cutting French fry potato strips from raw potatoes to have a selected cross sectional size and shape;
blanching the cut potato strips in hot water or steam for an extended time period to substantially completely cook the potato strips to form a soft and mealy internal texture, with increased sugar leaching;
adding a food grade coloring agent to the potato strips;
drying the blanched and colored potato strips for an extended time period at a relatively low dryer temperature to provide controlled moisture reduction substantially without the potato strips becoming tough and chewy;
passing the dried potato strips through a hot air impingement oven for a relatively short time interval and at a mid-level temperature range;
freezing the air impinged potato strips;
coating the frozen potato strips with oil; and
oven baking the potato strips to produce finished potato strips having relatively high quality sensory attributes and relatively low acrylamide levels.

2. The process of claim 1 wherein the cut potato strips have a generally square cross sectional shape of about 0.30 inch per side, and a length distribution ranging from about 2 inches to about 6 inches.

3. The process of claim 1 wherein said blanching step comprises blanching the cut potato strips in a hot water blanching medium for about 25-35 minutes, at a blanching medium temperature within a range of about 175-190° F.

4. The process of claim 1 wherein said blanching step comprises blanching the cut potato strips in a hot water blanching medium for about 30-60 minutes, at a blanching medium temperature within a range of about 130-155° F.

5. The process of claim 1 wherein said food grade coloring agent is added to the blanching medium.

6. The process of claim 5 wherein said food grade coloring agent is annatto, added at a rate within a range of from about 0.0007% to about 0.10% by weight of the blanch medium.

7. The process of claim 1 wherein the food grade coloring agent is applied to the blanched potato strips in the course of a post-blanch dwell step over a period of about 15 seconds to about 30 minutes and prior to subsequent processing.

8. The process of claim 1 wherein the surface-dyed potato strips exhibit an annatto-based color on the USDA approved Munsell color chart of about 0-3.

9. The process of claim 1 wherein the blanched and dyed potato strips are dried for about 65-105 minutes at a temperature of about 80-125° F. to produce dried strips having a moisture content of about 75% by weight, in combination with the desirable and relatively crispy outer skin.

10. The process of claim 1 wherein the dried potato strips are heated in an air impingement oven at a mid-level temperature range of about 250-400° F., for a short time interval on the order of about 1-3 minutes, wherein the air impingement oven operates within a relative humidity range of about 30-70% to produce air-impinged potato strips exit with a substantially fully developed crispy outer skin surface encasing a moist and mealy interior, while exhibiting a weight loss within the air impingement oven of about 5-30%.

11. The process of claim 1 wherein said freezing step comprises passing the air-impinged potato strips through a last freezer set at about −20° F.

12. The process of claim 1 wherein said oil coating step comprises lightly surface coating the frozen potato strips with a selected cooking oil to produce frozen oil-coated strips having an oil content of about 0.25-2.5% by weight.

13. The process of claim 12 wherein the selected cooking oil comprises a partially hydrogenated soy-based vegetable oil.

14. The process of claim 1 further comprising the step of seasoning the frozen potato strips.

15. The process of claim 14 wherein said seasoning step comprises adding salt at a rate of about 0.25-2.5% by weight of the potato strips.

16. The process of claim 15 wherein salt at a rate of about 1.5% by weight of the potato strips.

17. The process of claim 14 wherein said seasoning step comprises addition of a blended seasoning at a rate of about 1.0-10.0% by weight of the potato strips.

18. The process of claim 1 wherein said oven baking step comprises baking the potato strips substantially in a monolayer at a temperature of about 375-450° F. for a relatively short time period of about 6-30 minutes to produce resultant finish prepared potato strips having a relatively moist and mealy interior encasing a light and tender crispy exterior of golden brown color, in combination with a relatively low acrylamide level of the order of about 20-40 parts per billion (ppb).

19. The process of claim 18 wherein said oven baking step comprises baking the potato strips in a convection oven at a temperature of about 400-450° F. for a time period of about 6-12 minutes.

20. The process of claim 18 wherein the finish prepared potato strips exhibit a relatively low acrylamide level on order of less than about about 30 ppb.

21. A process for preparing French fry potato strips, comprising the steps of:
cutting French fry potato strips from raw potatoes to have a selected cross sectional size and shape;
blanching the cut potato strips in hot water or steam for an extended time period to substantially completely cook the potato strips to form a soft and mealy internal texture, with increased sugar leaching, said blanching step comprising blanching the cut potato strips in a hot water blanching medium for about 25-35 minutes, at a blanching medium temperature within a range of about 175-190° F.;
adding a food grade coloring agent comprising annatto to the potato strips;
drying the blanched and colored potato strips for an extended time period at a relatively low dryer temperature to provide controlled moisture reduction substantially without the potato strips becoming tough and chewy, said drying step comprising drying the potato strips for about 65-105 minutes at a temperature of about 80-125° F. to produce dried strips having a moisture content of about 75% by weight, in combination with the desirable and relatively crispy outer skin;
passing the dried potato strips through a hot air impingement oven for a relatively short time interval and at a mid-level temperature range, said air impingement oven being set at a mid-level temperature range of about 250-400° F., for a short time interval on the order of about 1-3 minutes, wherein the air impingement oven operates within a relative humidity range of about 30-70% to produce air-impinged potato strips exit with a substantially fully developed crispy outer skin surface encasing a moist and mealy interior, while exhibiting a weight loss within the air impingement oven of about 5-30%.;
freezing the air impinged potato strips;
coating the frozen potato strips with oil, said coating step comprising lightly surface coating the frozen potato strips with a selected cooking oil to produce frozen oil-coated strips having an oil content of about 0.25-2.5% by weight; and
oven baking the potato strips to produce finished potato strips having relatively high quality sensory attributes and relatively low acrylamide levels, said oven baking step comprising baking the potato strips substantially in a monolayer at a temperature of about 375-450° F. for a relatively short time period of about 6-30 minutes to produce resultant finish prepared potato strips having a relatively moist and mealy interior encasing a light and tender crispy exterior of golden brown color, in combination with a relatively low acrylamide level of the order of about 20-40 parts per billion (ppb).

22. The process of claim 21 wherein the cut potato strips have a generally square cross sectional shape of about 0.30 inch per side, and a length distribution ranging from about 2 inches to about 6 inches.

23. The process of claim 21 wherein annatto is added at a rate within a range of from about 0.0007% to about 0.10% by weight of the blanch medium.

24. The process of claim 21 wherein the surface-dyed potato strips exhibit an annatto-based color on the USDA approved Munsell color chart of about 0-3.

25. The process of claim 21 wherein the selected cooking oil comprises a partially hydrogenated soy-based vegetable oil.

26. The process of claim 21 wherein said oven baking step comprises baking the potato strips in a convection oven at a temperature of about 400-450° F. for a time period of about 6-12 minutes.

27. The process of claim 21 wherein the finish prepared potato strips exhibit a relatively low acrylamide level on order of less than about 30 ppb.

28. The product produced according to the process of claim 21.
